(19) United States
(12) Patent Application Publication
(10) Pub. No.: US 2014/0268832 A1
(43) Pub. Date: Sep. 18, 2014

(54) ILLUMINATION LIGHT SOURCE AND LIGHTING APPARATUS

(71) Applicant: PANASONIC CORPORATION, Osaka (JP)

(72) Inventors: Yoshiro GOTO, Osaka (JP); Kazuhiro TAKAMURA, Hyogo (JP); Koji NORO, Osaka (JP); Ryusuke KOTERA, Osaka (JP); Kensaku ATSUMI, Kyoto (JP)

(73) Assignee: PANASONIC CORPORATION, Osaka (JP)

(21) Appl. No.: 14/198,984

(22) Filed: Mar. 6, 2014

(30) Foreign Application Priority Data
Mar. 12, 2013 (JP) 2013-049701

(51) Int. Cl. F21K 99/00

(52) U.S. Cl. CPC F21K 9/00
USPC 362/382

(57) ABSTRACT

An LED unit which serves as illumination light source to be attached to lighting equipment, includes: a mounting board on which a light-emitting element, which emits light frontward, is provided; a support pad disposed behind the mounting board; and a case disposed so that the mounting board is sandwiched in a front-back direction by the case and the support pad. The support pad or the case includes insertion holes which are three or more openings into which securing components for securing the LED unit to the lighting equipment are inserted, and the three or more openings are disposed in such a way that, when a distance between two of the three or more openings is referred to as an inter-opening distance, at least one inter-opening distance is different from other inter-opening distances.

### CROSS REFERENCE TO RELATED APPLICATION

The present application is based on and claims priority of Japanese Patent Application No. 2013-049701 filed on Mar. 12, 2013. The entire disclosure of the above-identified application, including the specification, drawings and claims is incorporated herein by reference in its entirety.

### FIELD

The present invention relates to an illumination light source using a light-emitting element such as a light-emitting diode (LED) as a light source and to a lighting apparatus including the illumination light source.

### BACKGROUND

Conventionally, LED lamps which are disc-shaped or low-profile illumination light sources using LEDs as a light source have been proposed (for example, see Patent Literature (PTL) 1). An LED lamp such as that described above generally includes a board (substrate) on which light-emitting elements are provided, a support pad which supports the board, and a case, and the LED lamp is secured to lighting equipment by being screwed to the lighting equipment at two or three locations of the LED lamp.

### CITATION LIST

### Patent Literature

[PTL1] United States Unexamined Patent Application Publication No. 2012/0236532 Specification

### SUMMARY

### Technical Problem

However, with the above-described conventional LED lamp, there is the problem that, during the securing of the LED lamp to the lighting equipment, there are cases where the attachment orientation of the LED lamp is incorrect.

Specifically, with the above-described conventional LED lamp, there is usually no indicator in the attachment locations, and, thus, during the securing of the LED lamp to the lighting equipment, there are instances where the LED lamp is attached to the lighting equipment in the wrong orientation. Furthermore, even if there was an indicator in the attachment locations, there is still a possibility of making a mistake in the attachment orientation of the LED lamp when attaching the LED lamp to the lighting equipment. Subsequently, when the attachment orientation of the LED lamp is incorrect, there arise problems such as difficulty in connecting the wires for supplying power from the lighting equipment side, to the LED lamp.

The present invention is conceived in order to solve the aforementioned problem and has as an object to provide an illumination light source and a lighting apparatus which are capable of suppressing misoriented attachment during attachment of the LED lamp to lighting equipment.

### Solution to Problem

In order to achieve the aforementioned object, an illumination light source according to an aspect of the present invention is an illumination light source that is to be attached to lighting equipment, the illumination light source including: a board on which a light-emitting element, which emits light frontward, is provided; a support pad disposed behind the board; and a case disposed so that the board is sandwiched in a front-back direction by the case and the support pad, wherein the support pad or the case includes three or more openings into which securing components for securing the illumination light source to the lighting equipment are inserted, and the three or more openings are disposed in such a way that, when a distance between two of the three or more openings is referred to as an inter-opening distance, at least one inter-opening distance is different from other inter-opening distances.

Furthermore, the three or more openings may be disposed in such a way that, when a distance between each of the three or more openings and a center of the illumination light source is referred to as an opening-center distance, at least one opening-center distance is different from other opening-center distances.

Furthermore, the three or more openings may be disposed in such a way that equal angles are formed by line segments each connecting a different one of the three or more openings and a center of the illumination light source.

Furthermore, the three or more openings may be formed in a loop, in an outer circumference of the support pad or the case.

Furthermore, the support pad or the case may include three openings as the three or more openings, and the three openings may be disposed in such a way that one inter-opening distance is different from two other inter-opening distances.

Furthermore, in order to achieve the aforementioned object, a lighting apparatus according to an aspect of the present invention includes: the above-described illumination light source; and lighting equipment to which the illumination light source is attached, for supplying power to the illumination light source.

### Advantageous Effects

The present invention is capable of realizing an illumination light source capable of suppressing misoriented attachment during attachment of the LED lamp to lighting equipment, and a lighting apparatus including the illumination light source.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1A is a perspective view of an external appearance of an LED unit according to Embodiment 1 of the present invention when seen obliquely from the front.

FIG. 1B is a perspective view of an external appearance of the LED unit according to Embodiment 1 of the present invention when seen obliquely from the front.

FIG. 2 is a cross sectional-view for when the LED unit according to Embodiment 1 of the present invention is cut in the front-back direction (longitudinally).

FIG. 3 is an exploded perspective view of respective constituent components in the case where the LED unit according to Embodiment 1 of the present invention is disassembled.

FIG. 4 is a plan view for when a case according to Embodiment 1 of the present invention is seen from the front.

FIG. 5 is a plan view for when the case according to Embodiment 1 of the present invention is seen from the side and the back.

FIG. 6 is a plan view for when a support pad according to Embodiment 1 of the present invention is seen from the front.

FIG. 7 is a plan view for when the support pad according to Embodiment 1 of the present invention is seen from the side and the back.

FIG. 8 is a plan view for when the case and the support pad according to Embodiment 1 of the present invention are seen from the front.

FIG. 9 is a plan view for when the case and the support pad according to Embodiment 1 of the present invention are seen from the side and the back.

FIG. 10 is a perspective view illustrating the state in which the LED unit according to Embodiment 1 of the present invention is attached to lighting equipment.

FIG. 11 is a plan view of positions of insertion holes in the case according to Embodiment 1 of the present invention.

FIG. 12 is a plan view of positions of insertion holes in the support pad according to Embodiment 1 of the present invention.

FIG. 13 is a cross-sectional view of a configuration of a lighting apparatus according to Embodiment 2 of the present invention.

### DESCRIPTION OF EMBODIMENTS

Hereinafter, an LED unit (LED lamp), which serves as the illumination light source, and a lighting apparatus according to exemplary embodiments of the present invention shall be described with reference to the drawings. It should be noted that each of subsequently-described exemplary embodiments shows one specific preferred example of the present invention. The numerical values, shapes, materials, structural components, the arrangement and connection of the structural components, etc. shown in the following exemplary embodiments are mere examples, and are not intended to limit the scope of the present invention. Furthermore, among the structural components in the following exemplary embodiments, components not recited in any one of the independent claims are described as arbitrary structural components included in a more preferable form. Moreover, the respective figures do not necessarily show precise dimensions, etc.

### Embodiment 1

First, an outline configuration of an LED unit 1 according to Embodiment 1 of the present invention shall be described.

FIG. 1A is a perspective view of an external appearance of the LED unit 1 according to Embodiment 1 of the present invention when seen obliquely from the front. Furthermore, FIG. 1B is a perspective view of an external appearance of the LED unit 1 according to Embodiment 1 of the present invention when seen obliquely from the back. Furthermore, FIG. 2 is a cross sectional-view for when the LED unit 1 according to Embodiment 1 of the present invention is cut in the front-back direction (longitudinally). In addition, FIG. 3 is an exploded perspective view of respective constituent components in the case where the LED unit 1 according to Embodiment 1 of the present invention is disassembled.

Here, in FIG. 1A, FIG. 2, and FIG. 3, the LED unit 1 is illustrated in such a way that the side where light is elicited from the LED unit 1 (hereafter called light-emitting side) is the topside, and, in FIG. 1B, the LED unit 1 is illustrated in such a way that the light-emitting side is the underside. Hereinafter, description shall be carried out with the light-emitting side as the front side (front), the side opposite the light-emitting side as the back side (back), and a direction crossing the front-back (longitudinal) direction as a sideward direction.

As illustrated in these figures, the LED unit 1 is a low-profile illumination light source having a rectangular overall shape, and emits light by being attached to lighting equipment (not illustrated). Specifically, the LED unit 1 is an LED lamp having, for example, an outer diameter of between 50 and 100 mm and a height of between 10 and 30 mm. Here, the LED unit 1 includes a case 10, a mounting board 20, an insulator 30, and a support pad 40.

The case 10 is disposed on the light-emitting side (front) of the LED unit 1, and is a longitudinally-short, low-profile (disc-like) rectangular case. Specifically, the case 10 has an opening at a front portion and a back portion, and is connected to the support pad 40 at the back portion. In addition, the mounting board 20 and the insulator 30 are disposed in the space formed between the case 10 and the support pad 40. In other words, the case 10 is disposed so that the mounting board 20 is sandwiched in the front-back (longitudinal) direction by the case 10 and the support pad 40. The case 10 is configured of a resin case made of a synthetic resin having insulating properties, such as polybutylene terephthalate (PBT). Detailed description of the configuration of the case 10 shall be provided later.

The mounting board 20 is disposed inwards of the case 10 and is a substrate on which at least one light-emitting element 21a, which is a semiconductor light-emitting element or the like, is provided. The mounting board 20 is configured, for example, in the form of a plate, and has one face on which the light-emitting element 21a is provided and an other face which is thermally connectable to the support pad 40. Furthermore, it is preferable that the mounting board 20 be made of highly heat-conductive material, and is, for example, made of an alumina substrate made of alumina. It should be noted that, aside from an alumina substrate, a ceramic substrate made of other ceramic material such as aluminum nitride, metal substrates made of aluminum, copper, or the like, a resin substrate made of a highly heat-conductive resin, a metal-base substrate having a stacked structure of a metal and a resin, or the like, may be used for the mounting board 20.

Specifically, a light-emitting unit 21 having the light-emitting element 21a which emits light toward the front is provided in the mounting board 20. The light-emitting unit 21 includes one or plural LED chips (not illustrated) mounted on the mounting board 20, and a sealing component (not illustrated). The LED chips (chip) are mounted on one of the faces of the mounting board 20 by die bonding, or the like.

It should be noted that, for example, blue LED chips which emit blue light having a central wavelength at between 440 and 470 nm are used as the LED chips. Furthermore, the sealing component is a phosphor-containing resin made of a resin containing phosphor, for protecting the LED chips by sealing the LED chips, as well as for converting the wavelength of the light from the LED chips. As a sealing component, for example, in the case where the LED chips are blue light-emitting LEDs, a phosphor-containing resin in which yttrium, aluminum, and garnet (YAG) series yellow phosphor particles are dispersed in silicone resin can be used in order to obtain white light. With this, white light is emitted from the light-emitting unit 21 (sealing component) due to the yellow light obtained through the wavelength conversion by the phosphor particles and the blue light from the blue LED chips.

Furthermore, the outer diameter of the light-emitting unit 21 is, for example, between 5 and 50 mm, and when the LED unit 1 is a 20 W LED lamp, the outer diameter of the light-emitting unit 21 is, for example, 20 mm.

It should be noted that although a round light-emitting unit 21 is given as an example in this embodiment, the shape or structure of the light-emitting unit in the present invention is not limited to a round one. For example, a square-shaped light-emitting unit may be used. Furthermore, the arrangement of the LED chips is not particularly limited. For example, the LED chips may be sealed in a line, matrix, or circular form.

Furthermore, each of connectors 22 and 23 are disposed at a different corner of an edge portion of the mounting board 20, and, as illustrated in FIG. 1A, lead wire tip portions 22a and 23a located at the tips of corresponding lead wires for electrically connecting the lighting equipment and the light-emitting unit 21 are inserted into corresponding ones of the connectors 22 and 23. It should be noted that, in FIG. 1A, the lead wires are omitted in the illustration. Here, the lead wire tip portions 22a and 23a are power supply pins, and are specifically columnar metal pins. In other words, the LED chips of the light-emitting unit 21 are made to emit light by receiving power from the lighting equipment via the lead wire tip portions 22a and 23a and supplying the power to the light-emitting unit 21 via the wiring on the mounting board 20.

It should be noted that ground pins may be additionally inserted into the connectors 22 and 23, and, in the case where lighting control (dimming) is performed, lighting control pins may be inserted. Furthermore, the connectors 22 and 23 are not limited in their placement positions, and may be may be disposed anywhere. Furthermore, the shape of the lead wire tip portions 22a and 23a is not limited to a columnar shape and may be of any shape such as a rectangular column-shape, plate-like, and so on. Furthermore, the tips of the lead wires need not be provided with the lead wire tip portions 22a and 23a, and the lead wires may be directly inserted into the connectors 22 and 23.

The insulator 30 is a sheet having insulating properties for providing insulation between the mounting board 20 and the support pad 40, and is disposed so as to be sandwiched between the mounting board 20 and the support pad 40. Specifically, the insulator 30 is a component that is formed in a loop form so as to cover the circumference of the mounting board 20 in order to ensure the insulation distance between the live portion on the front face of the mounting board 20 and the support pad 40. The mounting board 20 and the support pad 40 are insulated from each other by placing the insulator 30 on the support pad 40 and placing the mounting board 20 on the insulator 30. It should be noted that the insulator 30 is, for example, a rubber or resin sheet, and is specifically formed from silicon, nylon, polyethylene terephthalate (PET), acrylic, or the like.

The support pad 40 is a component that is connected to the lighting equipment. Specifically, the support pad 40 is attached and secured to the lighting equipment by screw fastening, or the like. Furthermore, the support pad 40 is a mounting on which the mounting board 20 is attached, and is disposed on a side opposite (behind) the light-emitting side of the mounting board 20. Furthermore, since the support pad 40 is to be attached to the lighting equipment by screw fastening, or the like, the support pad 40 is preferably a metal component and is more preferably made of a highly head-conductive material such as aluminum, and the like. In other words, the support pad 40 plays a role in dissipating the heat of the mounting board 20, by conducting the heat of the mounting board 20 to the lighting equipment. It should be noted that the support pad 40 may be made of a highly heat-conductive resin or ceramic containing an inorganic filler. Detailed description of the configuration of the support pad 40 shall be provided later.

It should be noted that a heat-conductive heat-conducting component for releasing the heat from the mounting board 20 to the lighting equipment side may be disposed on the front face or back face of the support pad 40. As a heat-conducting component, it is possible to have a rubber or resin sheet such as a silicon sheet or an acrylic sheet, or a liquid component such as grease.

Furthermore, a reflecting mirror which reflects the light emitted from the light-emitting unit 21 may be connected to the inside or front of the case 10. Here, it is possible to have a reflecting mirror made from a white synthetic resin material having insulating properties, such as polycarbonate. Furthermore, a translucent cover may be disposed on the front face of the case 10. Here, it is possible to have a translucent cover made from a highly light-transmissive synthetic resin material such as polycarbonate.

Furthermore, a drive circuit having circuit elements (electronic components) which drive the light-emitting element 21a may be provided inside or outside of the case 10, to cause the light-emitting element 21a to emit light, stop emitting light, or to dim. As circuit elements, it is possible to have, for example, various types of capacitors, resistor elements, rectifier circuit elements, coil elements, choke coils (choke transistors), noise filters, diodes, or integrated circuit elements, and so on.

Next, the configuration of the case 10 shall be described in detail.

FIG. 4 is a plan view for when the case 10 according to Embodiment 1 of the present invention is seen from the front. Furthermore, FIG. 5 is a plan view for when the case 10 according to Embodiment 1 of the present invention is seen from the side and the back.

As illustrated in these figures, the case 10 includes a first case side face 11, a second case side face 12, and a third case side face 13. Here, the first case side face 11 is a region having a planar side face, the second case side face 12 is a region located opposite the first case side face 11 and having a planar side face. Furthermore, the third case side face 13 is a region connecting the first case side face 11 and the second case side face 12, and having a planar side face.

Specifically, the first case side face 11 includes first case flat faces 11a and lib, and a first case recess 11c. Here, the first case flat faces 11a and lib are planar side faces. Furthermore, the first case recess 11c is a concave side face disposed between the first case flat face 11a and the first case flat face 11b, and has an arc-like recessed shape. In other words, the first case side face 11 is shaped like a planar side face from which an arc shape has been cut out.

Furthermore, a case opening 11d, which is a circular cutout, is formed adjacent to the first case flat face lib in the first case side face 11, and the first case side face 11 includes a case engaging portion 11e which forms the case opening 11d. Here, the case opening 11d is an opening into which an after-mentioned securing component for securing the LED unit 1 to the lighting equipment is inserted, and the case engaging portion lie is formed to allow engagement with the securing component. Detailed description of the configuration of the case engaging portion 11e shall be provided later.

The second case side face 12 includes second case flat faces 12a and 12b, and a second case recess 12c. Here, the second case flat faces 12a and 12b are planar side faces, and are disposed at positions opposed to the first case flat faces 11a and 11b. Furthermore, the second case recess 12c is a concave side face disposed at a position which is between the second case flat face 12a and the second case flat face 12b and opposed to the first case recess 11c, and has an arc-like recessed shape. In other words, like the first case side face 11, the second case side face 12 is shaped like a planar side face from which an arc shape has been cut out.

Furthermore, a case opening 12d, which is a circular cutout, is formed adjacent to the second case flat face 12b in the first case side face 12, and the second case side face 12 includes a case engaging portion 12e which forms the case opening 12d. Here, like the case opening 11d, the case opening 12d is an opening into which a securing component for securing the LED unit 1 to the lighting equipment is inserted, and the case engaging portion 12e is formed to allow engagement with the securing component Detailed description of the configuration of the case engaging portion 12e shall be provided later.

The third case side face 13 includes third case flat faces 13a and 13b, and case curved faces 13c and 13d. Here, the third case flat faces 13a and 13b are planar side faces, and the case curved faces 13c and 13d are curved side faces disposed so as to sandwich the third case flat faces 13a and 13b. Specifically, the case curved face 13c is a curved face which is disposed between the second case flat face 12a and the third case flat face 13a, connects the second case flat face 12a and the third case flat face 13a, and has an arc-shaped cross-section. Furthermore, the case curved face 13d is a curved face which is disposed between the first case flat face 11a and the third case flat face 13b, connects the first case flat face 11a and the third case flat face 13b, and has an arc-shaped cross-section.

Furthermore, a case opening 13e having a shape obtained by cutting out a circular shape between the third case flat face 13a and the third case flat face 13b is formed in the third case side face 13, and the third case side face 13 includes a case engaging portion 13f which forms the case opening 13e. Here, like the case openings 11d and 12d, the case opening 13e is an opening into which a securing component for securing the LED unit 1 to the lighting equipment is inserted, and the case engaging portion 13f is formed to allow engagement with the securing component. Detailed description of the configuration of the case engaging portion 13f shall be provided later.

As described above, the three of the case openings 11d, 12d, and 13e are formed in a loop in the outer circumference of the case 10, and each of the case engaging portions 11e, 12e, and 13f is disposed for the corresponding one of the three case openings 11d, 12d, and 13e. Here, the engaging portions 11e, 12e, and 13f are disposed at positions far from the center of the case 10.

Furthermore, as illustrated in FIG. 5, the case 10 includes case projections 14, 15, 16, and 17 for connecting with the support pad 40. The case projections 14, 15, 16, and 17 are a plate-like protrusions projecting toward the inside of the case 10, and the case projection 14 and the case projection 15 are disposed opposed to each other, and the case projection 16 and the case projection 17 are disposed opposed to each other In other words, the pair of the case projections 14 and 15 and the pair of the case projections 16 and 17 are connected to the support pad 40, and the case is secured to the support pad 40.

It should be noted that the shape of the case 10 is not limited to that described above, the first case side face 11 and the second case side face 12 may be planar regions in which the first case recess 11c and the second case recess 12c are not formed, and the first case side face 11, the second case side face 12, or the third case side face 13 may be a curved region. In other words, the case 10 may be of any shape, such as polygonal, circular, or the like when seen from the front.

Next, the configuration of the support pad 40 shall be described in detail.

FIG. 6 is a plan view for when the support pad 40 according to Embodiment 1 of the present invention is seen from the front. Furthermore, FIG. 7 is a plan view for when the support pad 40 according to Embodiment 1 of the present invention is seen from the side and the back.

As illustrated in these figures, the support pad 40 includes a first support pad side face 41, a second support pad side face 42, and a third support pad side face 43. Here, the first support pad side face 41 is a region having a planar side face, and the second support pad side face 42 is a region which is disposed at a position opposed to the first support pad side face 41 and has a planar side face. Furthermore, the third support pad side face 43 is a region which connects the first support pad side face 41 and the second support pad side face 42, and has a planar side face.

Specifically, the first support pad side face 41 includes first support pad flat faces 41a and 41b, and a first support pad recess 41c. Here, the first support pad flat faces 41a and 41b are planar side faces. Furthermore, the first support pad recess 41c is a concave side face disposed at a position which is (i) between the first support pad flat face 41a and the first support pad flat face 41b and (ii) corresponds to the first case recess 11c, and has a rectangularly-recessed shape. In other words, the first support pad side face 41 is shaped like a planar side face from which a rectangular shape has been cut out.

Furthermore, a support pad opening 41d, which is a semi-circular cutout, is formed adjacent to the first support pad flat face 41b in the first support pad side face 41, and the first support pad side face 41 includes a support pad securing portion 41e which forms the support pad opening 41d. In other words, the support pad securing portion 41e is formed by cutting out a semi-circular shape in the outer circumference of the support pad 40. Here, the support pad opening 41d is an opening into which a securing component for securing the LED unit 1 to the lighting equipment is inserted, and the support pad securing portion 41e is a region which secures the support pad 40 to the lighting equipment by being secured to the lighting equipment using the securing component. Detailed description of the configuration of the support pad securing portion 41e shall be provided later.

The second support pad side face 42 includes second support pad flat faces 42a and 42b, and a second support pad recess 42c. Here, the second support pad flat faces 42a and 42b are planar side faces, and are disposed at positions opposed to the first support pad flat faces 41a and 41b. Furthermore, the second support pad recess 42c is a concave side face disposed between the second support pad flat face 42a and the second support pad flat face 42b, and has a rectangularly-recessed shape. Furthermore, the second support pad recess 42c is disposed at a position which corresponds to the second case recess 12c and is opposed to the first support pad recess 41c. In other words, the first support pad recess 41c and the second support pad recess 42c are a pair of opposed rectangular cutouts, and, like the first support pad side face 41, the second support pad side face 42 is shaped like a planar side face from which a rectangular shape has been cut out.

Furthermore, a support pad opening 42d, which is a semi-circular cutout, is formed adjacent to the second support pad flat face 42b in the second support pad side face 42, and the second support pad side face 42 includes a support pad securing portion 42e which forms the support pad opening 42d. In other words, the support pad securing portion 42e is formed by cutting out a semi-circular shape in the outer circumference of the support pad 40. Here, like the support pad opening 41d, the support pad opening 42d is an opening into which a securing component for securing the LED unit 1 to the lighting equipment is inserted, and the support pad securing portion 42e is a region which secures the support pad 40 to the lighting equipment by being secured to the lighting equipment using the securing component. Detailed description of the configuration of the support pad securing portion 42e shall be provided later.

The third support pad side face 43 includes third support pad flat faces 43a and 43b, and support pad curved faces 43c and 43d. Here, the third support pad flat faces 43a and 43b are planar side faces, and the support pad curved faces 43c and 43d are curved side faces disposed so that the third support pad flat faces 43a and 43b are sandwiched between them. In other words, the support pad curved face 43c is a curved face which is disposed between the second support pad flat face 42a and the third support pad flat face 43a, connects the second support pad flat face 42a and the third support pad flat face 43a, and has an arc-shaped cross-section. Furthermore, the support pad curved face 43d is a curved face which is disposed between the first support pad flat face 41a and the third support pad flat face 43b, connects the first support pad flat face 41a and the third support pad flat face 43b, and has an arc-shaped cross-section.

Furthermore, a support pad opening 43e having a shape obtained by cutting out an approximate semi-circular shape between the third support pad flat face 43a and the third support pad flat face 43b is formed in the third support pad side face 43, and the third support pad side face 43 includes a support pad securing portion 43f which forms the support pad opening 43e. In other words, the support pad securing portion 43f is formed by cutting out a semi-circular shape in the outer circumference of the support pad 40. Here, like the support pad openings 41d and 42d, the support pad opening 43e is an opening into which a securing component for securing the LED unit 1 to the lighting equipment is inserted, and the support pad securing portion 43f is a region which secures the support pad 40 to the lighting equipment by being secured to the lighting equipment using the securing component. Detailed description of the configuration of the support pad securing portion 43f shall be provided later.

As described above, the three of the support pad openings 41d, 42d, and 43e are formed in a loop in the outer circumference of the support pad 40, and each of the case engaging portions 11e, 12e, and 13f is disposed for the corresponding one of the three support pad openings 41d, 42d, and 43e.

Furthermore, as illustrated in FIG. 7, the support pad 40 includes support pad grooves 44, 45, 46, and 47 for connecting with the case 10. The support pad grooves 44, 45, 46, and 47 are grooves formed in the outer circumference of the support pad 40, with the pair of the support pad grooves 44 and 45 being disposed to allow engagement with the pair of the case projections 14 and 15, and the pair of the support pad grooves 46 and 47 being disposed to allow engagement with the pair of the case projections 16 and 17. In other words, the case 10 and the support pad 40 are secured to each other by connecting the pair of the support pad grooves 44 and 45 with the pair of the case projections 14 and 15, and connecting the pair of the support pad grooves 46 and 47 with the pair of the case projections 16 and 17.

It should be noted that the shape of the support pad 40 is not limited to that described above, the first support pad side face 41 or the second support pad side face 42 may be a planar region in which the first support pad opening 41c or the second support pad opening 42c is not formed, or the first support pad side face 41, the second support pad side face 42, or the third support pad side face 43 may be a curved region. In other words, the support pad 40 may be of any shape, such as polygonal, circular, or the like, when seen from the front.

Next, the positional relationship between the case 10 and the support pad 40 in the state where the case is secured to the support pad 40 shall be described in detail.

FIG. 8 is a plan view for when the case 10 and the support pad 40 according to Embodiment 1 of the present invention are seen from the front. Furthermore, FIG. 9 is a plan view for when the case 10 and the support pad 40 according to Embodiment 1 of the present invention are seen from the side and the back. Furthermore, FIG. 10 is a perspective view illustrating the state in which the LED unit 1 according to Embodiment 1 of the present invention is attached to lighting equipment 60.

It should be noted that, for convenience of description, the mounting board 20 and the insulator 30 are omitted from the LED unit 1 and only the case 10 and the support pad 40 are illustrated in FIG. 8 and FIG. 9. Furthermore, in FIG. 10, the lighting equipment 60 is illustrated in simplified form.

First, as illustrated in FIG. 8 and FIG. 9, in the state where the case 10 is secured to the support pad 40, the corresponding ones of the case engaging portions 11e, 12e, and 13f and the support pad securing portions 41e, 42e, and 43f, are opposingly disposed to form insertion holes 51, 52, and 53, respectively. It should be noted that in these figures, the case 10 and the support pad 40 are secured to each other by way of the corresponding ones of the support pad grooves 44, 45, 46, and 47 and the case projections 14, 15, 16, and 17 engaging with each other.

Here, as illustrated in FIG. 10, each of the insertion holes 51, 52, and 53 is an opening for the insertion of a securing component 70. In other words, attaching holes 60a for inserting and securing the securing components 70 are formed in the lighting equipment 60, and the LED unit 1 is attached to the lighting equipment 60 by way of the securing components 70 being inserted into the insertion holes 51, 52, 53, and secured using the attaching holes 60a. It should be noted that the securing components 70 are, for example, screws for securing the LED unit 1 to the lighting equipment 60 by screwing.

Specifically, the case engaging portion 11e and the support pad securing portion 41e are opposingly disposed so as to form the insertion hole 51 for the insertion of a securing component 70. In other words, the insertion hole 51 is formed by (i) the case opening 11d formed by the case engaging portion lie and (ii) the support pad opening 41d formed by the support pad securing portion 41e.

Furthermore, the case engaging portion 12e and the support pad securing portion 42e are opposingly disposed so as to form the insertion hole 52 for the insertion of a securing component 70. In other words, the insertion hole 52 is formed by (i) the case opening 12d formed by the case engaging portion 12e and (ii) the support pad opening 42d formed by the support pad securing portion 42e.

Furthermore, the case engaging portion 13f and the support pad securing portion 43f are opposingly disposed so as to form the insertion hole 53 for the insertion of a securing component 70. In other words, the insertion hole 53 is formed by (i) the case opening 13e formed by the case engaging portion 13f and (ii) the support pad opening 43e formed by the support pad securing portion 43f.

In this manner, in the state where the case 10 and the support pad 40 are interlocked, the case 10 and the support pad 40 form the insertion holes 51, 52, and 53 which are three openings into which the securing components 70 for securing the LED unit 1 to the lighting equipment 60 are inserted.

Next, the positions of the insertion holes 51, 52, and 53 which are three openings shall be described in detail.

FIG. 11 is a plan view of the positions of the insertion holes 51, 52, and 53 in the case 10 according to Embodiment 1 of the present invention. Furthermore, FIG. 12 is a plan view of the positions of the insertion holes 51, 52, and 53 in the support pad 40 according to Embodiment 1 of the present invention.

As illustrated in these figures, the insertion holes 51, 52, and 53, which are three openings, are disposed in such a way that, when the distance between two out of the three openings is referred to as an inter-opening distance, at least one inter-opening distance is different from the other inter-opening distances. In other words, the three insertion holes 51, 52, and 53 are disposed so that one of the inter-opening distances is different from the other two inter-opening distances.

Specifically, the three insertion holes 51, 52, and 53 are disposed so that an inter-opening distance A, which is the inter-opening distance between the insertion hole 51 and the insertion hole 52, is different from (i) an inter-opening distance B which is the inter-opening distance between the insertion hole 52 and the insertion hole 53 and (ii) an inter-opening distance C which is the inter-opening distance between the insertion hole 51 and the insertion hole 53. In this embodiment, the insertion holes 51, 52, and 53 are disposed so that the inter-opening distance A is greater than the inter-opening distance B and the inter-opening distance C.

Furthermore, the three insertion holes 51, 52, and 53 are disposed in such a way that, when the distance between each of the openings and the center of the LED unit 1 is referred to as an opening-center distance, at least one opening-center distance is different from the other opening-center distances. Here, the center of the LED unit 1 refers to a point located at the center of the LED unit 1, and, specifically, matches the center of gravity of the plan view shape of the LED unit 1 in the case where the LED unit 1 is seen from the front. It should be noted that, since the LED unit 1 has a low-profile shape, the point corresponding to the center of gravity in the plane including the aforementioned three openings may be defined as the center of the LED unit 1. Furthermore, in the case where the light-emitting unit 21 is disposed at the center portion of the LED unit 1 (in the case where the center of the light-emitting unit 21 and the aforementioned center of gravity match) when the LED unit 1 is seen from the front, the center of the light-emitting unit 21 may be defined as the center of the LED unit 1.

Specifically, the three insertion holes 51, 52, and 53 are disposed so that an opening-center distance D, which is the distance between the insertion hole 53 and a center O of the LED unit 1, is different from (i) an opening-center distance E which is the distance between the insertion hole 52 and the center O and (ii) an opening-center distance F which is the distance between the insertion hole 51 and the center O. In this embodiment, the insertion holes 51, 52, and 53 are disposed so that the opening-center distance D is less than the opening-center distance E and the opening-center distance F.

Furthermore, the insertion holes 51, 52, and 53, which are three openings, are disposed in such a way that equal angles are formed by line segments each connecting a different one of the openings and the center of the LED unit 1. Specifically, the three insertion holes 51, 52, and 53 are disposed so that an angle a, an angle b, and an angle c are equal. Here, the angle a is the angle formed by (i) the line segment connecting the insertion hole 51 and the center O of the LED unit 1 and (ii) the line segment connecting the insertion hole 52 and the center O. Furthermore, the angle b is the angle formed by (i) the line segment connecting the insertion hole 52 and the center O and (ii) the line segment connecting the insertion hole 53 and the center O. Furthermore, the angle c is the angle formed by (i) the line segment connecting the insertion hole 51 and the center O and (ii) the line segment connecting the insertion hole 53 and the center O.

Furthermore, the insertion holes 51, 52, and 53, which are three openings, are formed in a loop in the outer circumference of the case 10, and are formed in a loop in the outer circumference of the support pad 40. In other words, in the state where the case 10 and the support pad 40 are interlocked, the insertion holes 51, 52, and 53 are formed in a loop in the outer circumference of the LED unit 1.

As described above, according to the LED unit 1 which is the illumination light source according to Embodiment 1 of the present invention, the case 10 and the support pad 40 form the insertion holes 51, 52, and 53 which are three openings into which the securing components 70 for securing the LED unit 1 to the lighting equipment 60 are inserted. In addition, the three insertion holes 51, 52, and 53 are disposed so that the inter-opening distance A is different from the other inter-opening distances B and C. In this manner, at least one of the inter-opening distances of the three insertion holes 51, 52, and 53 into which the securing components 70 are to be inserted is different from the other inter-opening distances. Therefore, even if improperly-oriented (misoriented) attaching is attempted during the attaching of the LED unit 1 to the lighting equipment 60, the positions of the attaching holes 60a on the lighting equipment 60 side and the insertion holes 51, 52, and 53 on the LED unit 1 side do not match each other and thus attachment is not possible.

Furthermore, the insertion holes 51, 52, and 53, which are three openings, are disposed so that the opening-center distance D is different from the other opening-center distances E and F. In other words, at least one of the opening-center distances of the three insertion holes 51, 52, and 53 into which the securing components 70 are to be inserted is different from the other opening-center distances. As such, because of this too, even if improperly-oriented attaching is attempted during the attaching of the LED unit 1 to the lighting equipment 60, the positions of the attaching holes 60a on the lighting equipment 60 side and the insertion holes 51, 52, and 53 on the LED unit 1 side do not match each other and thus attachment is not possible.

As described above, during the attaching of the LED unit 1 to the lighting equipment 60, it is possible to prevent attaching with the wrong orientation for the LED unit 1.

Furthermore, the insertion holes 51, 52, and 53, which are three openings, are disposed in such a way that equal angles are formed by line segments each connecting a different one of the insertion holes and the center of the LED unit 1. This allows for well-balanced attachment of the LED unit 1 to the lighting equipment 60.

Furthermore, the insertion holes 51, 52, and 53, which are three openings, are formed in a loop in the outer circumference of the support pad 40 or the case 10. As such, since the insertion holes 51, 52, and 53 can be formed by cutting out the outer circumference of the support pad 40 or the case 10, the insertion holes 51, 52, and 53 can be formed easily. Furthermore, it is possible to suppress reduction in surface area of the support pad 40 caused by the forming of the insertion holes 51, 52, and 53, and ensure sufficient heat-dissipation from the support pad 40 to the lighting equipment 60.

### Embodiment 2

Next, a lighting apparatus 100 according to Embodiment 2 of the present invention shall be described.

FIG. 13 is a cross-sectional view of a configuration of the lighting apparatus 100 according to Embodiment 2 of the present invention. It should be noted that the lighting apparatus 100 according to this embodiment uses the LED unit 1 according to Embodiment 1. Therefore, in the figure, the same reference signs are given to structural components that are the same as the structural components shown in Embodiment 1.

As illustrated in the figure, the lighting apparatus 100 is, for example, a downlight that is attached to a ceiling wall 200, and includes the lighting equipment 60, and the LED unit 1 according to Embodiment 1. The lighting equipment 60 is equipment onto which the LED unit 1 is attached for supplying power to the LED unit 1, and includes a main body 61 configured to cover the LED unit 1, and a power source circuit 62 which supplies power to the LED unit 1. Furthermore, the main body 61 includes a heat-dissipating component 61a and a reflecting component 61b, and the power source circuit 62 includes a lead wire 62a.

The heat-dissipating component 61a is a region which dissipates the heat transmitted from the LED unit 1. The heat-dissipating component 61a houses the power source circuit 62 therein, and the LED unit 1 is secured to its front face (bottom face). In other words, as illustrated in FIG. 10, the LED unit 1 is secured to the bottom face of the heat-dissipating component 61a by the securing components 70. It should be noted that the LED unit 1 is attached to the heat-dissipating component 61a in a detachable manner.

Here, the shape of the heat-dissipating component 61a is not necessarily limited as long as it is a shape that is suited to heat dissipation, and it is possible to have, for example, a shape in which fins are formed radially along the outer circumference. Furthermore, it is preferable that the heat-dissipating component 61a be made of highly heat-conductive material such as aluminum.

The reflecting component 102 is substantially in the shape of a cup having a circular opening formed on the front portion (bottom portion), and is configured so as to laterally surround the LED unit 1. Specifically, the reflecting component 61b is a cylindrical region which is formed to have an inner diameter that gradually increases from the bottom face of the heat-dissipating component 61a downward.

In other words, the reflecting component 61b has an opening on the light-emitting side, and is configured to reflect the light from the LED unit 1. For example, the reflecting component 61b is made of a white synthetic resin having insulating properties. It should be noted that, in order to improve reflectivity, the inner face of the reflecting component 61b may be coated with a reflective film. It should be noted that the reflecting component 61b is not limited to one that is made from synthetic resin, and a metal reflecting plate formed by press-working a metal plate may be used.

The power source circuit 62 is a component for supplying direct current power to the LED unit 1. In other words, circuit elements (electronic components) for converting alternating current power into direct current power are provided in the power source circuit 62, and the power source circuit 62 receives alternating current power, converts this to direct current power, and supplies the direct current power to the LED unit 1 via the lead wire 62a. It should be noted that the lighting apparatus 100 may be realized by having electronic components for dimming the LED unit 1 provided in the power source circuit 62, and allowing light-modulation (dimming) of the LED unit 1 through the lighting equipment 60.

As described above, according to the lighting apparatus 100 according to Embodiment 2 of the present invention, the inclusion of the LED unit 1 according to Embodiment 1 makes it possible to produce the same advantageous effects as in Embodiment 1. It should be noted that the same modification as in Embodiment 1 may be carried out in this embodiment.

Although the LED unit 1 as an illumination light source and the lighting apparatus 100 according to the embodiments of the present invention have been described, the present invention is not limited to the above-described embodiments. Specifically, the embodiments disclosed herein should be considered, in all points, as examples and are thus not limiting. The scope of the present invention is defined not by the foregoing description but by the Claims, and includes all modifications that have equivalent meaning to and/or are within the scope of the Claims.

Furthermore, forms obtained by arbitrarily combining the above-described embodiments are also included in the scope of the present invention. Furthermore, the present invention may be configured by arbitrarily combining partial configurations in the above-described embodiments.

For example, although the insertion holes 51, 52, and 53 are formed through the interlocking of the case 10 and the support pad 40 in the foregoing embodiments, the present invention is not limited to this configuration. In other words, the insertion holes 51, 52, and 53 may be formed in the case 10 and thus the case 10 may independently form the insertion holes 51, 52, and 53, alternatively, the insertion holes 51, 52, and 53 may be formed in the support pad 40 and thus the support pad 40 may independently form the insertion holes 51, 52, and 53.

Furthermore, although three of the insertion holes 51, 52, and 53 are formed in the LED unit 1 in the foregoing embodiments, it is sufficient that the number of insertion holes be at least three. In other words, it is sufficient that at least three insertion holes, which are openings into which the securing components 70 for securing the LED unit 1 to the lighting equipment 60 are inserted, are formed in the support pad 40 or the case 10, and that the at least three openings be disposed so that at least one inter-opening distance is different from the other inter-opening distances. Furthermore, the at least three openings may be disposed so that at least one opening-center distance is different from the other opening-center distances, and the at least three openings may be disposed so that the equal angles are formed by line segments each connecting a different one of the openings to the center of the LED unit 1. Furthermore, the at least three openings may be formed in a loop in the outer circumference of the support pad 40 or the case 10.

Furthermore, although the securing components 70 are screws and the LED unit 1 is secured to the lighting equipment 60 by screwing in the foregoing embodiments, the securing components 70 are not limited to screws and the method of securing using the securing components 70 need not be by screwing, as long as securing according to the configuration illustrated in FIG. 10 is possible.

Furthermore, although the insertion holes 51, 52, and 53, which are three openings, are disposed so that at least one opening-center distance is different from the other opening-center distances in the foregoing embodiments, the insertion holes 51, 52, and 53 may be disposed so that all the opening-center distances are the same. Even in this case, by having a configuration in which at least one inter-opening distance is different from the other inter-opening distances, it is possible to prevent attaching with a wrong orientation for the LED unit 1 during the attaching of the LED unit 1 to the lighting equipment 60.

Furthermore, although the insertion holes 51, 52, and 53, which are three openings, are disposed so that equal angles are formed by line segments each connecting a different one of the openings and the LED unit 1, the present invention is not limited to such configuration, and the angles formed may be any angle.

Furthermore, although the insertion holes 51, 52, and 53 are formed by cutting out parts of the outer circumference of the support pad 40 in the foregoing embodiments, the insertion holes 51, 52, and 53 may be formed by forming at least one through hole in the support pad 40 and providing a corresponding number of support pad securing portions around the through hole. This is also true for the case engaging portions.

Furthermore, optical components such as a lens or reflector for focusing the light from the light-emitting unit, or optical filters, and the like, for color tone-adjustment may be used in the foregoing embodiments. However, such components are not essential components for the present invention.

Furthermore, although the light-emitting unit 21 has a COB-type configuration in which the LED chip is directly mounted on the mounting board 20, the configuration of the light-emitting unit is not limited to such. For example, it is also acceptable to use a surface mounted device (SMD) light-emitting unit configured by using packaged LED elements, in each of which the LED chip is mounted inside a cavity formed using resin and the inside of the cavity is enclosed by a phosphor-containing resin, and mounting a plurality of the LED elements on a board.

Furthermore, although the light-emitting unit 21 is configured to emit white light by using a blue light-emitting LED and yellow phosphor in the foregoing embodiments, the present invention is not limited to such configuration. For example, it is possible to emit white light by using a phosphor-containing resin which contains red phosphor and green phosphor, and combining such resin with a blue light-emitting LED.

Furthermore, the light-emitting unit 21 may use an LED which emits light of a color other than blue. For example, when using an ultraviolet light-emitting LED chip as the LED, a combination of respective phosphor particles for emitting light of the three primary colors (red, green, blue) can be used as the phosphor particles. In addition, a wavelength converting material other than phosphor particles may be used, and, as a wavelength converting material, it is possible to use a material including a substance which absorbs light of a certain wavelength and emits light of a wavelength different to that of the absorbed light, such as a semiconductor, a metal complex, an organic dye, or a pigment.

Furthermore, although an LED is given as an example of a light-emitting element 21a in the foregoing embodiments, semiconductor light-emitting elements such as a semiconductor laser, or light-emitting elements such as organic electro luminescence (EL) elements or non-organic EL elements may be used.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

1. An illumination light source that is to be attached to lighting equipment, the illumination light source comprising:
a board on which a light-emitting element, which emits light frontward, is provided;
a support pad disposed behind the board; and
a case disposed so that the board is sandwiched in a front-back direction by the case and the support pad,
wherein the support pad or the case includes three or more openings into which securing components for securing the illumination light source to the lighting equipment are inserted, and
the three or more openings are disposed in such a way that, when a distance between two of the three or more openings is referred to as an inter-opening distance, at least one inter-opening distance is different from other inter-opening distances.

2. The illumination light source according to claim 1,
wherein the three or more openings are disposed in such a way that, when a distance between each of the three or more openings and a center of the illumination light source is referred to as an opening-center distance, at least one opening-center distance is different from other opening-center distances.

3. The illumination light source according to claim 1,
wherein the three or more openings are disposed in such a way that equal angles are formed by line segments each connecting a different one of the three or more openings and a center of the illumination light source.

4. The illumination light source according to claim 1,
wherein the three or more openings are formed in a loop, in an outer circumference of the support pad or the case.

5. The illumination light source according to claim 1,
wherein the support pad or the case includes three openings as the three or more openings, and
the three openings are disposed in such a way that one inter-opening distance is different from two other inter-opening distances.

6. A lighting apparatus comprising:
the illumination light source according to claim 1; and
lighting equipment to which the illumination light source is attached, for supplying power to the illumination light source.
